(19) United States
(12) Patent Application Publication
(10) Pub. No.: US 2025/0006102 A1
(43) Pub. Date: Jan. 2, 2025

(54) BRIGHTNESS COMPENSATION FOR CAMERA UNDER DISPLAY SUBPIXELS

(71) Applicant: Intel Corporation, Santa Clara, CA (US)

(72) Inventors: Susanta Bhattacharjee, Bangalore (IN); Kunjal Parikh, Fremont, CA (US)

(21) Appl. No.: 18/343,392

(22) Filed: Jun. 28, 2023

(51) Int. Cl. G09G 3/20; G09G 3/3208

(52) U.S. Cl. CPC G09G 3/2096; G09G 3/3208; G09G 2320/0233; G09G 2320/0626; G09G 2360/16

(57) ABSTRACT

A device, including: processing circuitry operable to determine boosted subpixel values for subpixels in a camera under display (CUD) area of a display panel, wherein each boosted subpixel value is based on a ratio of a non-CUD subpixel aperture area to a CUD subpixel aperture area for a corresponding subpixel of the display panel; and a display driver operable to boost a brightness of each subpixel in the CUD area based on the respective boosted subpixel value.

### TECHNICAL FIELD

Aspects described herein generally relate to a device with a Camera Under Display (CUD), mainly brightness compensation for subpixels in an area of the CUD.

### BACKGROUND

Camera Under Display (CUD) technology is designed to achieve a seamless edge-to-edge display by eliminating the need for a notch-out region. However, implementing this technology poses challenges, such as limited transparency of Organic Light-Emitting Diode (OLED) screens.

Traditional solutions that utilize high-density image sensors and a smaller aperture in the CUD area to compensate for the lower transmittance of the OLED screen have drawbacks. The smaller aperture in the CUD area fails to adequately compensate for brightness, color chromaticity, and different saturation points, leading to image mismatch between the CUD and non-CUD areas. Using a higher-resolution sensor increases the device's thickness and undermines the goal of achieving a thin and lightweight form factor. Employing an asymmetric aperture structure to increase transparency in the CUD area can result in image artifacts due to an imbalance in pixel tone caused by the lower aperture and increased transparency in the CUD area. Visual artifacts become imbalanced and noticeable in high grey scale areas because CUD pixels are operated at the same current density as non-CUD pixels. Moreover, implementing CUD technology may affect the reliability of OLED displays as the pixels are driven at different stress points, potentially leading to display failure.

### BRIEF DESCRIPTION OF THE FIGURES

FIG. 1A illustrates a schematic diagram of a display panel.

FIG. 1B illustrates a close-up portion of the display panel of FIG. 1A.

FIG. 2 illustrates a schematic diagram of a device in accordance with aspects of the disclosure.

FIGS. 3A-3C illustrate an original image, an uncompensated image, and a well-compensated image, respectively, in accordance with aspects of the disclosure.

FIGS. 4A-4C illustrate an original image, an uncompensated image, and a partially-compensated image by boosting subpixel values, respectively, in accordance with aspects of the disclosure.

FIG. 5 illustrates a bitmask in accordance with aspects of the disclosure.

### DETAILED DESCRIPTION

The present disclosure is directed to a device having a display panel with a camera under display (CUD) area and a non-CUD area, and brightness compensation for the CUD area based on a ratio of a non-CUD subpixel aperture area to a CUD subpixel aperture area of respective sub-pixels in the CUD area.

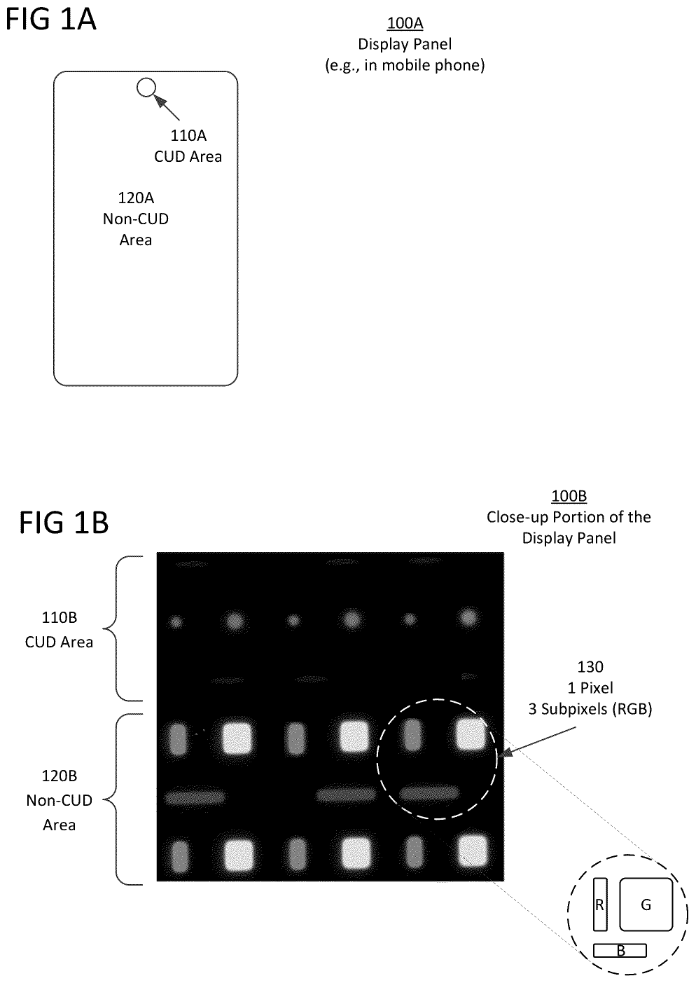

FIG. 1A illustrates a schematic diagram of a display panel 100A, such as that of a mobile phone. FIG. 1B illustrates a close-up portion 100B of the display panel 100A of FIG. 1A. The display panel 100A/100B comprises a CUD area 110A/110B and a non-CUD area 120A/120B.

A pixel, also known as a picture element, is the smallest unit of addressability within the display panel 100A. In the display panel 100, a single pixel is composed of subpixels, usually arranged in groups of three: red (R), green (G), and blue (B), forming an RGB subpixel triad. These subpixels are generally rectangular in shape, with a portion emitting light and another portion being opaque. The emitting portion is referred to as the aperture, and its size is fixed for a specific display panel design but may vary between display panels. Although the RGB subpixels may have varying sizes, together, they usually form a pixel 130 that is approximately square in shape. The same subpixel pattern is typically repeated across all pixels 130.

The subpixels in the CUD area 110A/110B have smaller apertures than those in the non-CUD area 120A/120B. As a result, despite being driven with the same current as the subpixels in the non-CUD area 120A/120B, the subpixels in the CUD area 110A/110B exhibit lower brightness. This disparity in brightness is depicted in FIG. 1B, illustrating that the subpixels in the CUD area 110A/110B are less bright compared to those in the non-CUD area 120A/120B.

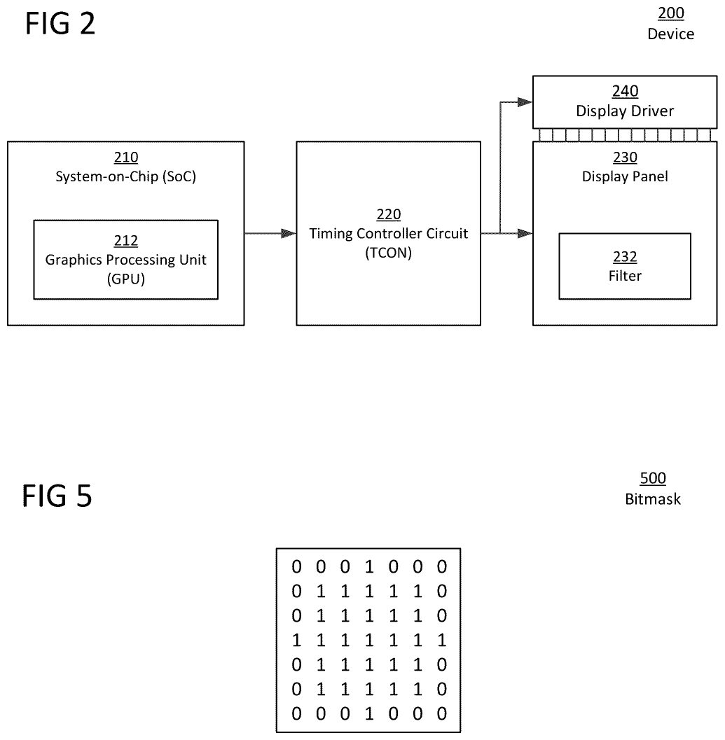

FIG. 2 illustrates a schematic diagram of device 200 in accordance with aspects of the disclosure.

Device 200 comprises System-on-Chip (SoC) 210, a timing controller circuit 220, a display panel 230, and a display driver 240. Device 200 may be a mobile phone, laptop, external monitor, game console, or the like.

The SoC 210 is an integrated circuit incorporating various device components and circuits, including the Graphics Processing Unit (GPU) 212. The GPU 212 is a specialized electronic circuit designed to efficiently manipulate memory, thereby accelerating the process of generating images within a frame buffer. These images are ultimately intended for output by the display panel 230.

The timing controller circuit 220 separates the data transmitted from the SoC 210 into digital image data and control signals. Subsequently, it delivers these signals to the display panel 230 and the display driver 240.

The display panel 230 can be constructed using various emissive display technologies, such as Organic Light-Emitting Diode (OLED) or micro-LED (Light Emitting Diode). In the case of an OLED display panel, it includes solid-state devices that emit light when adjacent electrodes drive a current. To generate red, green, and blue light to render full-color images, there are two main approaches. The first is to pattern red, green, and blue OLED subpixels in each pixel of the display panel 230. This is generally a preferred approach for high-resolution mobile displays. A second approach is to produce white light in every pixel, and then use a color filter 232 to produce red, green, and blue sub-pixels. If the display panel 230 were a liquid crystal display (LCD) panel, it would incorporate an optical polarizing filter 232.

The display driver 240 is operable to receive image data, including subpixel values, and generate electrical signals that drive the subpixels of the display panel 230. This process enables display panel 230 to display a visual image. The display driver 240 may incorporate digital-to-analog converters (DACs) to convert the subpixel values into analog signals. Additionally, it utilizes row and column drivers to generate suitable currents for driving the subpixels. The color of light emitted by each subpixel is determined by the emissive material used in its construction.

The brightness of each RGB subpixel corresponds to its subpixel value, typically represented as an 8-bit digital value. For instance, the subpixel values may range from 0 to 255. A subpixel value of 0 results in the subpixel being completely dark, while a value of 255 makes the subpixel as bright as possible. In the case of a white pixel, all RGB subpixels are driven with a subpixel value of 255, representing the maximum value. However, a gray pixel has all RGB subpixels driven with the same RGB subpixel value that is less than 255. Other colors have RGB subpixels driven with different subpixel values that are less than or equal to 255.

The subpixel values are determined by the GPU 212 and/or the timing controller circuit 220. The GPU 212 is responsible for transmitting digital data. At the same time, the timing controller circuit 220 organizes this digital data to enable the display driver 240 to adjust voltages and driving currents, raising or lowering them accordingly.

The optical polarizing filter 232, in the case of an LCD display panel, is operable to regulate the brightness of each subpixel based on their respective subpixel values. Positioned in front of the subpixels, it interacts with a backlight behind it. Without applied voltage, the optical polarizing filter 232 remains in a normal position, entirely blocking light from the backlight. As the voltage gradually increases, the filter causes the liquid crystals to reorient, permitting more light from the backlight to pass through. When a digital subpixel value of 255 is reached, the liquid crystals undergo an almost 90-degree transition, becoming fully transparent. This transition results in the corresponding subpixel attaining maximum brightness.

As previously mentioned, although the subpixels in the CUD area 110A/110B are driven with the same current as the non-CUD area 120A/120B, their brightness is inherently lower. To compensate for the diminished brightness of the subpixels in the CUD area 110A/110B, subpixel values of subpixels in the CUD area 110A/110B are boosted in accordance with aspects of this disclosure.

The processing circuitry, which comprises the GPU 212 and/or the timing controller circuit 220, determines the boosted subpixel values for the subpixels located within the CUD area 110A/110B. Ideally, these boosted subpixel values are determined so that the overall perceived brightness of the subpixels in the entire CUD area 110A/110B, that is, the aggregate brightness from the CUD area 110A/110B, becomes substantially similar to that of the non-CUD area 120A/120B. The processing circuitry may perform this determination when the display panel 230 is connected to the rest of the device 200, ensuring optimal visual consistency across the display.

Each boosted subpixel value is calculated using Equation 1, which incorporates a ratio of the non-CUD subpixel aperture area to the CUD subpixel aperture area for the respective subpixel. This ratio is raised to the power of one divided by the gamma value of the display panel 230 and then multiplied by the corresponding input subpixel value. Equation 1 represents this calculation as follows:

$$Boosted Subpixel Value = Power ( ( non - CUD subpixel aperture area ) / ( CUD subpixel aperture area ) , 1. / panel gamma ) * input subpixel value . \qquad ( Equation 1 )$$

The gamma value for the display panel 230 is a fixed value, typically 2.2. The subpixel values for the RGB subpixels are generally boosted proportionally, although this disclosure is not limited in this regard. In simpler terms, for each subpixel of each pixel, the boosted subpixel value (denoted as V′) is calculated using the following formula: V′=X^{Y}V, where X represents the ratio (X=(non-CUD subpixel aperture area)/(CUD subpixel aperture area)), Y defines 1/γ (gamma value), and V represents the input subpixel value. The specific ratio X is determined by the physical layout of the device 200 and is therefore fixed by the display panel manufacturer. However, parameters can vary between laptop designs. A manufacturer may utilize a driver installation file (INF) or video BIOS table to accommodate design-specific customization.

The optical polarizing filter 232 enhances the brightness of each subpixel within the CUD area 110A/110B according to its corresponding boosted subpixel value.

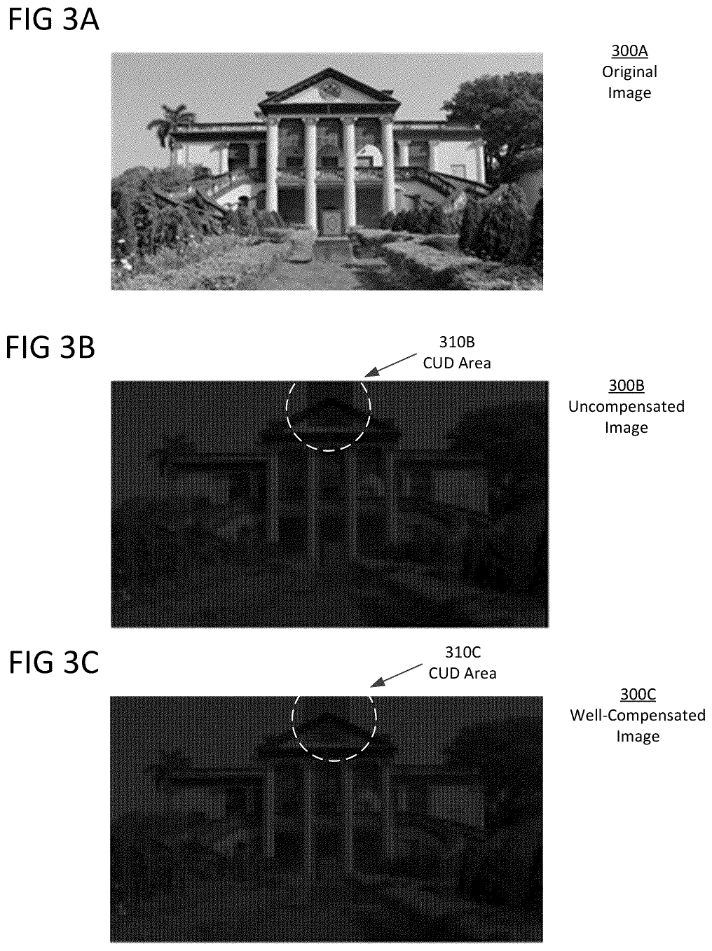

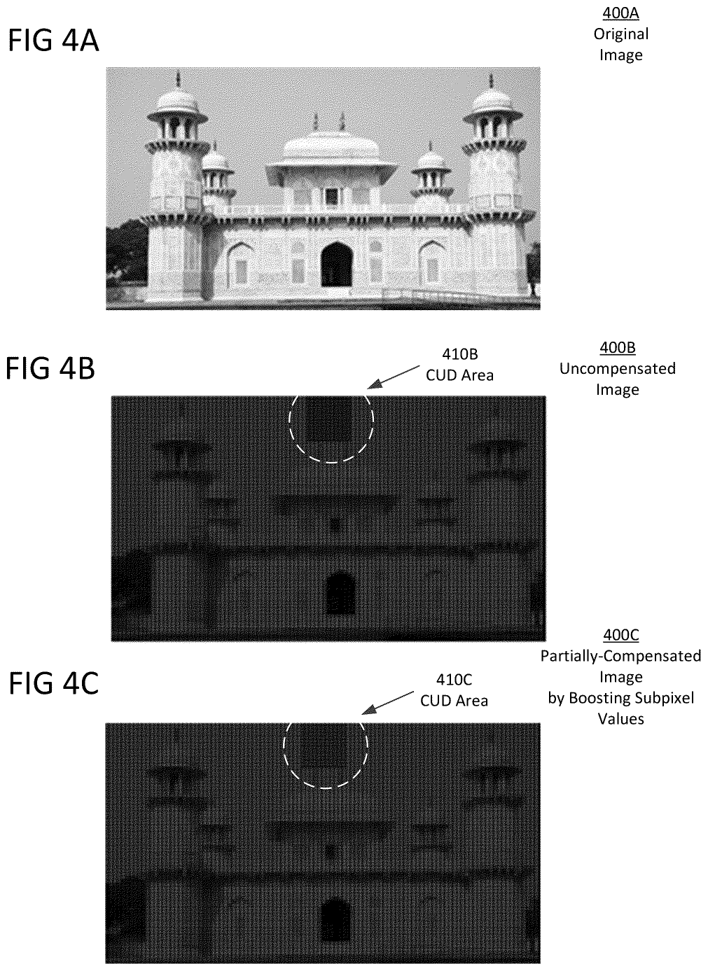

FIGS. 3A-3C and 4A-4C illustrate two simulation results that showcase the brightness enhancement within the CUD area 310/410. FIGS. 3A-3C present the original image 300A, an uncompensated image 300B, and a well-compensated image 300C, respectively. FIGS. 4A-4C present the original image 400A, an uncompensated image 400B, and a partially-compensated image 400C achieved by boosting subpixel values in accordance with aspects of the disclosure.

In the simulation, pixels represent subpixels, leading to a pixelated appearance. However, the images will appear smooth without pixelation on a physical system. A non-pixelated view can be observed when viewing the simulated result images from a distance. The CUD area 310/410 is distinguishable at the top middle section of the uncompensated images in FIGS. 3B and 4B. The assumed ratio of the CUD aperture area to the non-CUD aperture area is 21/44.

A limit constrains the digital subpixel values, and exceeding this limit results in clipping. Equation 2 establishes the maximum value of the boosted subpixel, a value between the determined boosted subpixel value and the maximum possible subpixel value of the display panel, typically 255 in an 8 Bits Per Color (BPC) scheme. For example, if the intention is to boost a subpixel value three times, and the original subpixel value is 200, attempting to boost it to 600 is not feasible. Instead, the boosted subpixel value is clipped to 255. In an 8 Bits Per Color (BPC) configuration, for the assumed ratio of CUD aperture to non-CUD aperture area of 21/44, subpixel values exceeding 182 will be clipped.

$$Boosted Subpixel Value = Min ( Boosted Subpixel Value , 255 ) \qquad ( Equation 2 )$$

The limitation is evident in the image displayed in FIG. 4C, where the effectiveness of brightness compensation in the CUD area 410C is less pronounced than in the CUD area 310C of FIG. 3C due to clipping. The boosted value employed in the simulation utilizes a power of (44/21, 1/2.2), with 44/21 representing the ratio of non-CUD subpixel aperture area to CUD subpixel aperture area, and 1/2.2 representing 1.0 divided by the panel gamma (2.2). Generally, frames containing brighter pixels within the CUD area (such as a bright sky) cannot fully compensate using this subpixel value-boosting approach.

An alternative approach for enhancing the brightness of sub-pixels in the CUD area 110A/110B is implemented to overcome the limitation of pixel value clipping. Instead of boosting subpixel values, the display driver 240 drives higher currents through the subpixels within the CUD area 110A/110B.

The processing circuitry, comprising GPU 212 and/or timing controller circuit 220, is operable to determine current boost factors for subpixels within the CUD area 110A/110B. Each current boost factor is calculated based on the ratio of the non-CUD subpixel aperture area to the CUD subpixel aperture area for the corresponding subpixel. This ratio is represented by the following equation 3:

$$Subpixel current boost factor = ( Non - CUD Sub pixel aperture area ) / ( CUD sub - pixel aperture area ) \qquad ( Equation 3 )$$

The display driver 240 can boost the driving current for each subpixel within the CUD area 110A/110B, utilizing the corresponding current boost factors.

FIG. 5 illustrates a bitmask 500 in accordance with aspects of the disclosure

The CUD area 110A/110B/310/410 can be substantially rectangular or non-rectangular, such as circular. When a non-rectangular shape is employed, the CUD area 110A/110B/310/410 may be defined by combining a substantially rectangular physical area in the display panel and a bitmask 500.

In this case, the bitmask 500 comprises one bit per pixel, where 1s indicate the CUD area 110A/110B/310/410. The CUD area 110/310/410 is depicted as circular. Usually, the bitmask 500 is identical for all pixels, but there is also the option of using a separate bitmask for each of the three subpixels.

The GPU 212 can transmit the position, dimensions, bitmask 500, and current boost factors of the CUD area rectangle to the timing controller circuit 220 using a known mechanism such as DisplayPort Configuration Data (DPCD) registers.

The disclosed aspects described herein are intended to address visual artifacts by achieving a harmonized representation of the red, green, and blue (RGB) curves within a rectangular CUD area. This is achieved by creating headroom in the overdrive of the display panel pixel design. Furthermore, these aspects efficiently regulate overcompensation levels within the CUD area to ensure the longevity of the display panel.

The GPU 212 and/or timing controller circuit 220 can execute instructions in non-transitory computer-readable storage media. These storage media encompass both volatile and nonvolatile, removable and non-removable media, implemented through various methods or techniques for information storage. The information stored may include computer-readable instructions, data structures, program modules, or other forms of data. Examples of non-transitory computer-readable storage media include but are not limited to, RAM, ROM, EEPROM, flash memory or other memory technologies, CD-ROM, DVD, or other optical storage devices, magnetic cartridges, magnetic tapes, disk storage devices, or any other non-transmitting media used for storing information accessible by a computer device.

The techniques of this disclosure may also be described in the following examples.

### Example 1

1. A device, comprising: processing circuitry operable to determine boosted subpixel values for subpixels in a camera under display (CUD) area of a display panel, wherein each boosted subpixel value is based on a ratio of a non-CUD subpixel aperture area to a CUD subpixel aperture area for a corresponding subpixel of the display panel; and a display driver operable to boost a brightness of each subpixel in the CUD area based on the respective boosted subpixel value.

Example 2. The device of example 1, wherein each of the boosted subpixel values is the respective determined ratio to a power of one divided by a gamma value of the display panel, multiplied by a respective input subpixel value.

Example 3. The device of any one or more of examples 1-2, wherein each of the boosted subpixel values is a minimum of the determined boosted subpixel value and a maximum possible subpixel value of the display panel.

Example 4. The device of any one or more of examples 1-3, wherein the processing circuitry is a graphics processing unit (GPU).

Example 5. The device of any one or more of examples 1-4, wherein the processing circuitry is a timing controller circuit.

Example 6. The device of any one or more of examples 1-5, wherein the processing circuitry is operable to determine the boosted subpixel values such that aggregate brightness of the subpixels in the CUD area is substantially similar to that of a non-CUD area of the display panel.

Example 7. The device of any one or more of examples 1-6, wherein the processing circuitry is operable to determine the boosted subpixel values when the display panel is connected to the device.

Example 8. The device of any one or more of examples 1-7, wherein the display panel is an emissive display panel.

Example 9. The device of any one or more of examples 1-8, wherein the display panel is an organic light-emitting diode (OLED) display panel.

Example 10. A device, comprising: processing circuitry operable to determine current boost factors for subpixels in a camera under display (CUD) area of a display panel, wherein each current boost factor is based on a ratio of a non-CUD subpixel aperture area to a CUD subpixel aperture area for a corresponding subpixel of the display panel; and a display driver operable to boost a driving current based on the respective current boost factors for each subpixel in the CUD area.

Example 11. The device of example 10, wherein the CUD area is substantially rectangular.

Example 12. The device of any one or more of examples 10-11, wherein the CUD area has a shape that is non-rectangular and defined by a physical area that is substantially rectangle with an overlying bitmask.

Example 13. The device of any one or more of examples 10-12, wherein the processing circuitry is a graphics processing unit (GPU).

Example 14. The device of any one or more of examples 10-13, wherein the processing circuitry is a timing controller circuit.

Example 15. The device of any one or more of examples 10-14, wherein the processing circuitry is operable to determine the current boost factors such that aggregate brightness of the subpixels in the CUD area is substantially similar to that of a non-CUD area.

Example 16. The device of any one or more of examples 10-15, wherein the processing circuitry is operable to determine the current boost factors when the display panel is connected to the device.

Example 17. The device of any one or more of examples 10-16, wherein the display panel is an emissive display panel.

Example 18. The device of any one or more of examples 10-17, wherein the display panel is an organic light-emitting diode (OLED) display panel.

Example 19. A component of a system, comprising: processing circuitry; and a non-transitory computer-readable storage medium including instructions that, when executed by the processing circuitry, cause the processing circuitry to: determine boosted subpixel values for subpixels in a camera under display (CUD) area of a display panel having a CUD area and a non-CUD area, wherein each boosted subpixel value is based on a ratio of a non-CUD subpixel aperture area to a CUD subpixel aperture area for a corresponding subpixel; or determine current boost factors for the subpixels in the CUD area, wherein each current boost factor is based on the ratio of a non-CUD subpixel aperture area to a CUD subpixel aperture area for a corresponding subpixel.

Example 20. The component of example 19, wherein the boosted subpixel values or the current boost factors are determined such that aggregate brightness of the subpixels in the CUD area is substantially similar to that of the non-CUD area.

While the preceding has been described in conjunction with the exemplary aspects, it is understood that “exemplary” is merely meant as an example rather than the best or optimal. Accordingly, the disclosure is intended to cover alternatives, modifications, and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application will cover any adaptations or variations of the particular aspects discussed herein.

1. A device, comprising:
processing circuitry operable to determine boosted subpixel values for subpixels in a camera under display (CUD) area of a micro-LED (Light Emitting Diode) display panel, wherein each boosted subpixel value is based on a ratio of a non-CUD subpixel aperture area to a CUD subpixel aperture area for a corresponding subpixel of the micro-LED display panel; and
a display driver operable to boost a brightness of each subpixel in the CUD area based on the respective boosted subpixel value.

2. The device of claim 1, wherein each of the boosted subpixel values is the respective determined ratio to a power of one divided by a gamma value of the micro-LED display panel, multiplied by a respective input subpixel value.

3. The device of claim 1, wherein each of the boosted subpixel values is a minimum of the determined boosted subpixel value and a maximum possible subpixel value of the micro-LED display panel.

4. The device of claim 1, wherein the processing circuitry is a graphics processing unit (GPU).

5. The device of claim 1, wherein the processing circuitry is a timing controller circuit.

6. The device of claim 1, wherein the processing circuitry is operable to determine the boosted subpixel values such that aggregate brightness of the subpixels in the CUD area is substantially similar to that of a non-CUD area of the micro-LED display panel.

7. The device of claim 1, wherein the processing circuitry is operable to determine the boosted subpixel values when the micro-LED display panel is connected to the device.

8-18. (canceled)

19. A component of a system, comprising:
processing circuitry; and
a non-transitory computer-readable storage medium including instructions that, when executed by the processing circuitry, cause the processing circuitry to:
determine boosted subpixel values for subpixels in a camera under display (CUD) area of a micro-LED (Light Emitting Diode) display panel having a CUD area and a non-CUD area, wherein each boosted subpixel value is based on a ratio of a non-CUD subpixel aperture area to a CUD subpixel aperture area for a corresponding subpixel.

20. The component of claim 19, wherein the boosted subpixel values or the current boost factors are determined such that aggregate brightness of the subpixels in the CUD area is substantially similar to that of the non-CUD area.
